(19) United States
(12) Patent Application Publication
(10) Pub. No.: US 2017/0361748 A1
(43) Pub. Date: Dec. 21, 2017

(54) Assembly For Adjusting A Lumbar Region Of A Seat

(71) Applicant: Kongsberg Automotive, Inc., Novi, MI (US)

(72) Inventors: Scott Meachum, Milan, MI (US); Peter Ellis, Livonia, MI (US); Sai Pedaballe, Clawson, MI (US); Radu Popa, Fowlerville, MI (US); Joseph M. Laperriere, Chesterfield, MI (US)

(21) Appl. No.: 15/534,115

(22) PCT Filed: Dec. 8, 2015
(86) PCT No.: PCT/US2015/064515

§ 371 Date: Jun. 8, 2017

Related U.S. Application Data
(60) Provisional application No. 62/089,017, filed on Dec. 8, 2014.

(51) Int. Cl. B60N 2/66; A47C 7/46

(52) U.S. Cl. CPC B60N 2/6673; A47C 7/462; B60N 2/666; B60N 2/6671

(57) ABSTRACT

An assembly for adjusting a lumbar region of a seat frame. A support is provided for suspension in the frame and is movable between lumbar positions. An actuator having a chassis and a drive is attached to the support. A wire extends between a first end engaging the drive and a second end for attachment to the frame. First and second spaced guides are mounted to the support and slidably support the wire. An intermediate device supports the wire and has a mount for attachment to the frame. A conduit disposed about the wire has a first end coupled to the actuator and a second end mounted to the intermediate device such that movement of the drive moves the wire relative to the guides and the intermediate device so to move the first guide relative to the second wire end and the second guide relative to the intermediate device.

### BACKGROUND OF THE INVENTION

### 1. Field of the Invention

The present invention relates, generally, to vehicle seats and, more specifically, to an assembly for adjusting a lumbar region of a seat.

### 2. Description of the Related Art

Conventional seats known in the art include a base and a back configured to accommodate, support, and secure an occupant of a vehicle. The base is operatively attached to the vehicle, such as to a passenger compartment floorboard, and may be adapted to selectively move along the floorboard so as to effect selective legroom adjustment to accommodate differently-sized occupants. The back is pivotally attached to the base such that the occupant can selectively adjust the angular position of the back with respect to the base.

In addition to legroom adjustment and back/base angular position adjustment, seats known in the related art employ various mechanisms to facilitate adjustable support to the occupant at specific seat locations corresponding to anatomical regions of the body. By way of non-limiting example, the seat may include one or mechanisms to facilitate adjustment of lumbar support against the occupant's back, and/or bolster support against the occupant's hips, waist, or shoulders. Such selective adjustment is particularly advantageous when the occupant has been seated for an extended period of time.

There are a number of different types of mechanisms known in the related art for providing selectively adjustable support within a seat, including both manually-adjusted and power-adjusted mechanisms.

While seats and adjustment mechanisms known in the prior art have generally performed well for their intended purpose, there remains a need in the art for a seat adjustment mechanism assembly which strikes a substantial balance between packaging size, component cost, manufacturability, functionality, usability, and ergonomics.

### SUMMARY OF THE INVENTION

The present invention overcomes the disadvantages in the related art in an assembly for adjusting a lumbar region of a seat having a back frame. The assembly includes a seat support adapted for suspension in the back frame of the seat. The seat support is movable between a first lumbar position and a second lumbar position. An actuator is operatively attached to the seat support to concurrently move with the seat support between the lumbar positions. The actuator includes a chassis and a drive mechanism. A wire extends between first and second longitudinal ends. The first end of the wire operatively engages the drive mechanism of the actuator, and the second end of the wire is adapted for attachment to the back frame of the seat. A conduit is disposed about at least a portion of the wire and has first and second ends. The first end of the conduit is coupled to the actuator. A first guide is mounted to the seat support with a portion of the wire adjacent the second end of the wire being slideably supported by the first guide. A second guide is mounted to the seat support spaced from the first guide with a portion of the wire being slideably supported by the second guide. An intermediate mounting device is provided having a mount adapted for attachment to the back frame of the seat. A portion of the wire is supported by the intermediate mounting device. The second end of the conduit is mounted to the intermediate mounting device such that movement of the drive mechanism moves the wire relative to the guides and the intermediate mounting device to facilitate movement of the first guide relative to the second end of the wire and movement of the second guide relative to the intermediate mounting device.

In this way, the adjustment mechanism of the present invention provides improved functionality and usability in connection with automotive seating systems and, at the same time, reduces the cost and complexity of manufacturing and assembling seating systems with improved improved features, such as increased comfort, adjustability, and ergonomics.

### BRIEF DESCRIPTION OF THE DRAWINGS

Other advantages of the present invention will be readily appreciated as the same becomes better understood by reference to the following detailed description when considered in connection with the accompanying drawings.

FIG. 1 is a perspective view of a vehicle seat having a back frame in which an assembly according to one embodiment of the present invention is suspended for adjusting a lumbar region of the seat.

FIG. 2 is a perspective view of the back frame and the assembly of FIG. 1 showing a seat support, an actuator, a wire, a conduit, a first guide, a second guide, and an intermediate mounting device.

FIG. 2A is an enlarged view of the back frame and assembly of FIG. 2, showing additional detail of the conduit, wire, intermediate mounting device, and the second guide.

FIG. 2B is an another enlarged view of the back frame and assembly of FIG. 2, showing additional detail of the wire and the first guide.

FIG. 3 is a rotated perspective view of the assembly of FIG. 2.

FIG. 4 is a side view of the assembly of FIG. 3.

FIG. 5 is a rotated perspective view of the back frame and the assembly of FIG. 2.

FIG. 6 is an enlarged partial perspective view of the back frame and the assembly of FIG. 5.

FIG. 7 is a perspective view of the actuator of FIGS. 2-6.

FIG. 8 is a partially exploded perspective view of the actuator of FIG. 7, showing a chassis, a drive mechanism, and a cover.

FIG. 9A is a perspective view of the chassis and the drive mechanism of the actuator of FIGS. 7 and 8 with the drive mechanism shown in a first position.

FIG. 9B is an another perspective view of the actuator of FIG. 9A with the drive mechanism shown in a second position.

FIG. 10A is a perspective view of an assembly for adjusting the lumbar region of the seat of FIG. 1 according to another embodiment of the present invention, showing an actuator with a drive mechanism employing a cam and shown in a first position.

FIG. 10B is an enlarged partial perspective view of the actuator of the assembly of FIG. 10B with the drive mechanism and cam shown in a second position.

FIG. 11 is a perspective view of an assembly for adjusting the lumbar region of the seat of FIG. 1 according to yet another embodiment of the present invention having an actuator with a drive mechanism shown in phantom.

FIG. 11A is an enlarged view of the assembly of FIG. 11, showing additional detail of the actuator.

FIG. 12 is rotated perspective view of the assembly of FIG. 11.

FIG. 13A is a partial schematic top-side sectional view of the back frame and a portion of the assembly according to one embodiment of the invention shown with the seat support in the first lumbar position and with the actuator in a first position.

FIG. 13B is an another partial schematic top-side sectional view of the back frame and the assembly of FIG. 13A shown with the seat support in the second lumbar position and with the actuator in a second position.

### DETAILED DESCRIPTION OF THE INVENTION

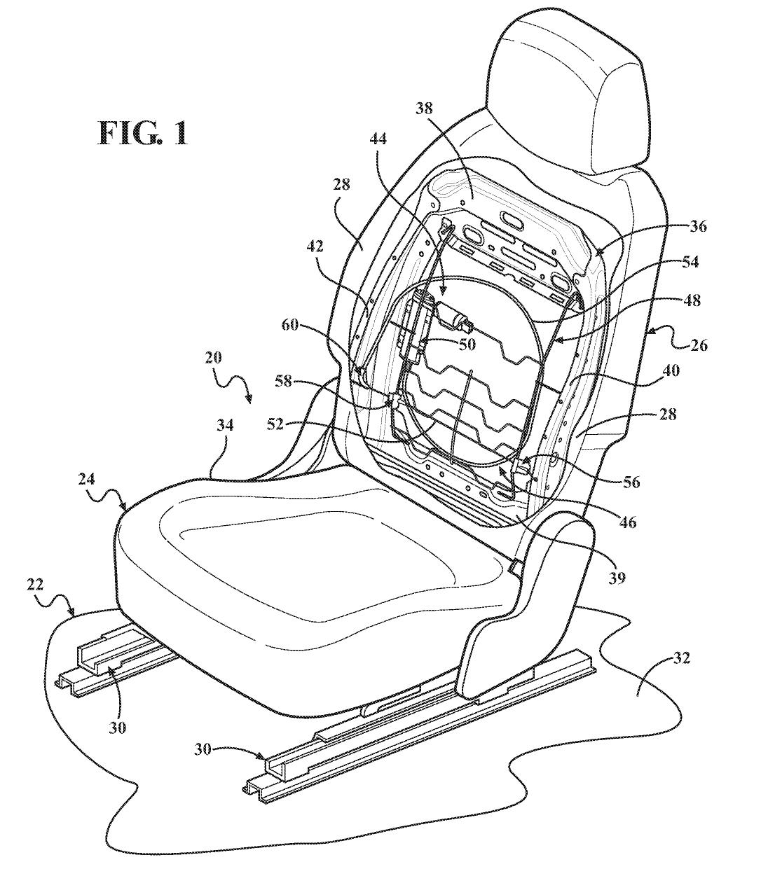

With reference now to the Figures, wherein like numerals indicate like parts throughout the several views, a seat is shown at 20 in FIG. 1. The seat 20 is configured to be mounted in a passenger compartment of a vehicle, generally indicated at 22, and is used to accommodate, secure, and support an occupant of the vehicle 22. To that end, the seat 20 includes a base, generally indicated at 24, and a back, generally indicated at 26. The base 24 accommodates and provides support to the occupant's buttocks and thighs. Similarly, the back 26 accommodates and provides support to the occupant's shoulders, back, waist, and/or hips. The base 24 and/or the back 26 may include bolsters 28 configured to provide lateral support to the occupant so as to urge or otherwise hold the occupant in a seated position on the seat 20. For example, the bolsters 28 may be sized, shaped, and/or oriented so as to prevent the occupant from moving laterally relative to the base 24 and/or the back 26.

The back 26 is pivotally attached to the base 24 such that the occupant can selectively adjust the angular position of the back 26 with respect to the base 24 (not shown in detail, but generally known in the related art). In the representative embodiment illustrated herein, the base 24 is operatively attached to the vehicle 22 via one or more slider assemblies, generally indicated at 30 which, in turn, are secured to a floorboard 32 of the vehicle 22. The slider assemblies 30 are configured to facilitate selective movement of the seat 20 with respect to the vehicle 22 floorboard 32 so as to effect selective legroom adjustment to accommodate differently-size occupants. By way of non-limiting example, where the seat 20 is used to accommodate an operator of the vehicle 22, the slider assemblies 30 allow the operator to move the seat 20 closer-to or further-away-from the vehicle 22 controls, such as the accelerator, brakes, and/or steering wheel (not shown, but generally known in the art), and may be manually-adjusted or power-adjusted. However, those having ordinary skill in the art will appreciate that the seat 20 could accommodate any occupant of the vehicle 22 and, thus, could be positioned in any suitable location (i.e., driver seat, front passenger seat, rear seat, etc.) secured to any suitable portion of the vehicle 22 in any suitable way, with or without the use of slider assemblies 30, without departing from the scope of the present invention. Moreover, while the vehicle 22 described herein is an automobile, those having ordinary skill in the art will appreciate that the vehicle 22 could be of any suitable type without departing from the scope of the present invention. By way of non-limiting example, the vehicle 22 could be adapted for civilian, commercial, industrial, military, or law enforcement use on land, water, or in the air.

The base 24 and back 26 of the seat 20 each include frames that provide structural rigidity and support to the seat 20 and facilitate connection between various components of the seat 20 as well as connection to the vehicle 22, and may extend within the bolsters 28 so as to support foam and/or cushions supported in the base 24 and/or the back 26 (not shown in detail, but generally known in the related art) underneath one or more outer upholstery covers of the seat 20, generally indicated at 34. Typically, frames are formed of metal, but could be formed or otherwise manufactured from any suitable material sufficient to provide proper support for the occupant. The base 24 of the seat 20 includes a base frame (not shown) supported therein adapted to connect the base 24 to the slider assemblies 30, and the back 26 of the seat 20 includes a back frame 36 supported therein (see FIG. 1). The back frame 36 includes a top cross support 38 and a bottom cross support 39 spaced from and aligned substantially parallel to the top cross support 38. The back frame 36 further includes first and second side supports 40, 42 extending between the top cross support 38 and bottom cross support 39 to define a periphery of the back frame 36.

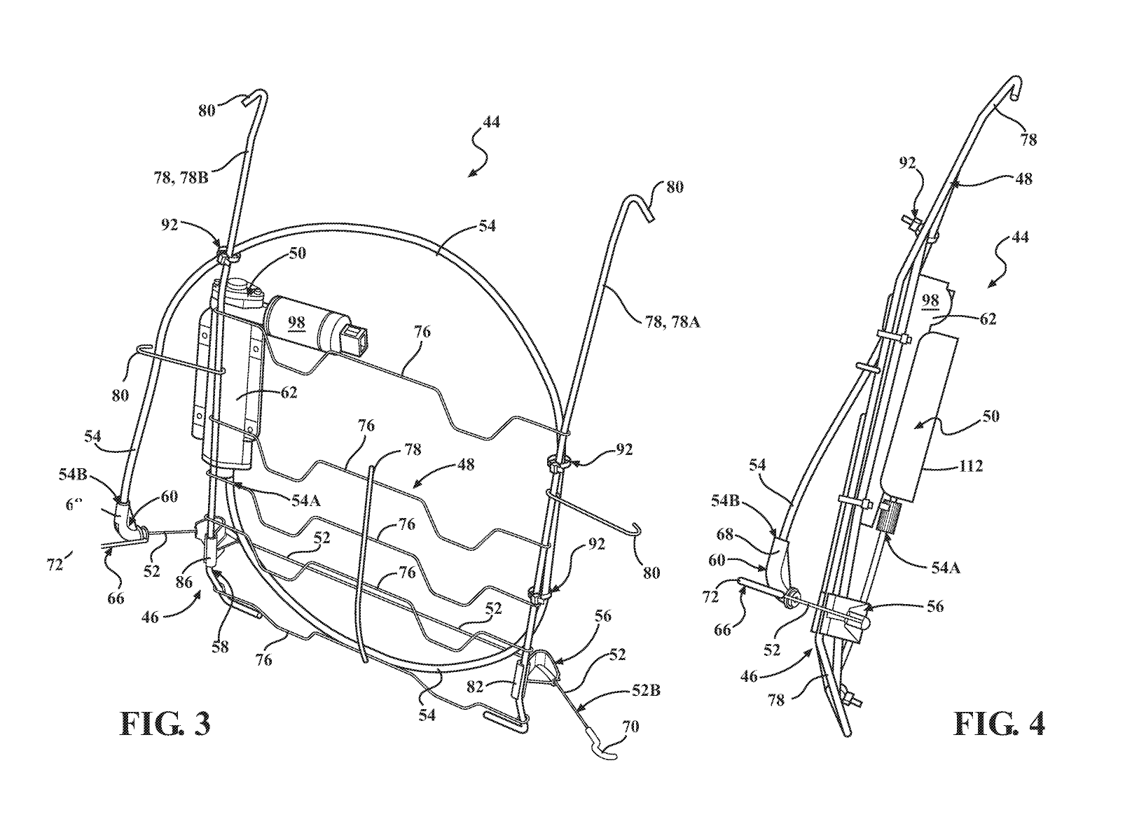

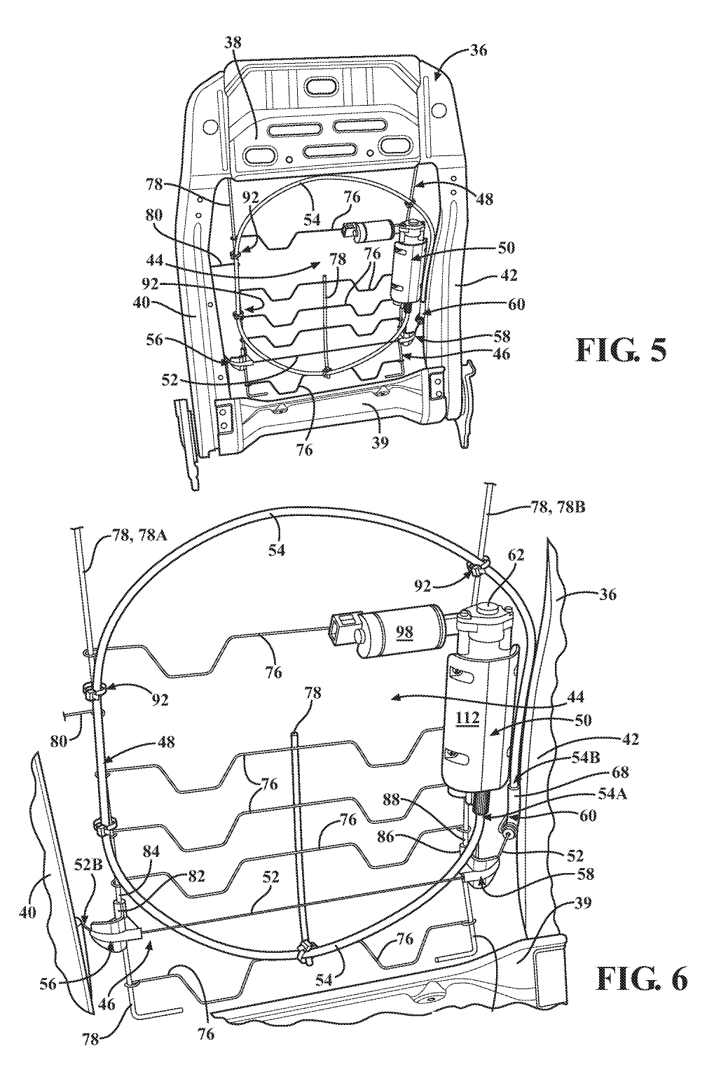

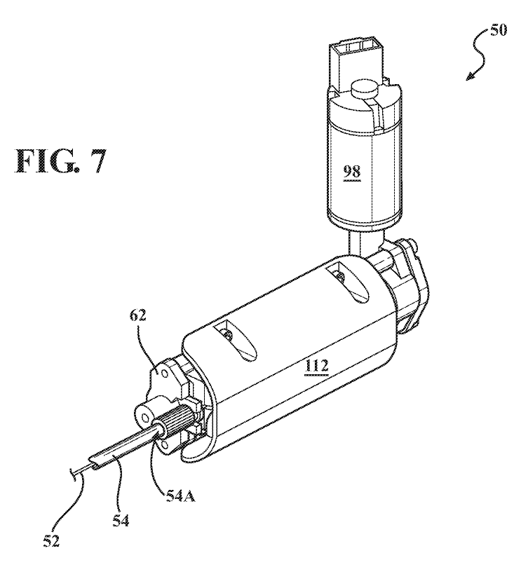

Referring now to FIGS. 1-9B, an assembly 44 according to the present invention is mounted within the back frame 36 of the back 26 of the seat 20 for adjusting a lumbar region of the seat 20, generally indicated at 46. To that end, the assembly 44 includes a seat support 48, an actuator 50, a wire 52, a conduit 54, a first guide 56, a second guide 58, and an intermediate mounting device 60 which cooperate to facilitate selective adjustment of the lumbar region 36 of the seat 20. Each of these components will be described in greater detail below.

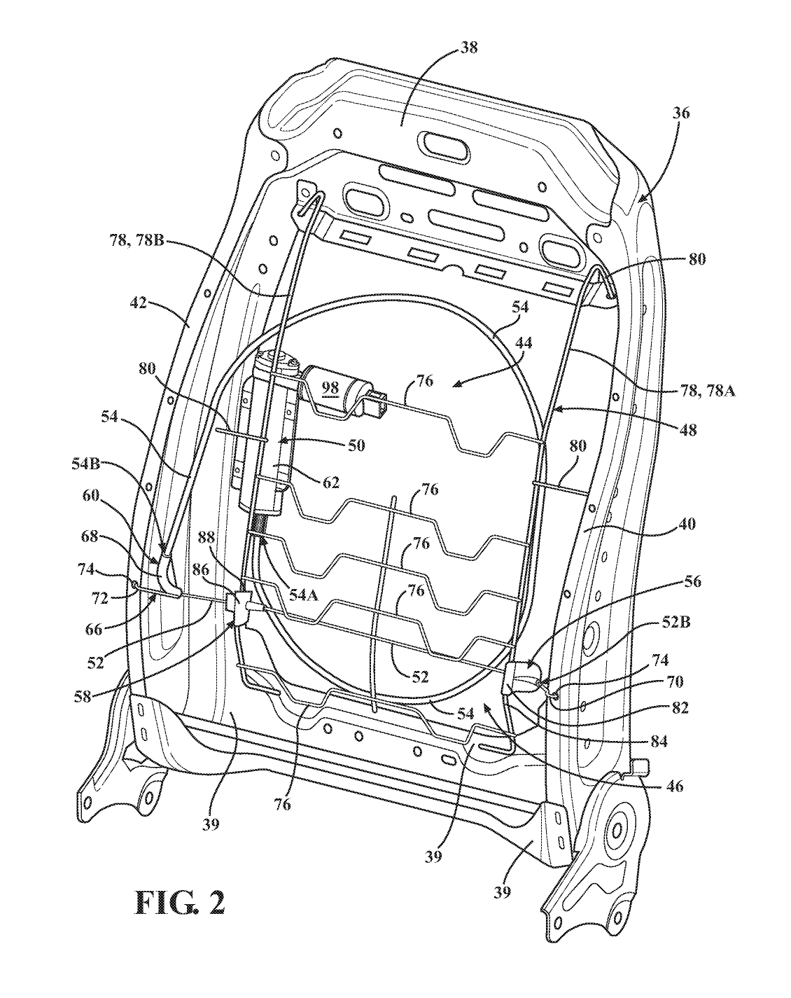

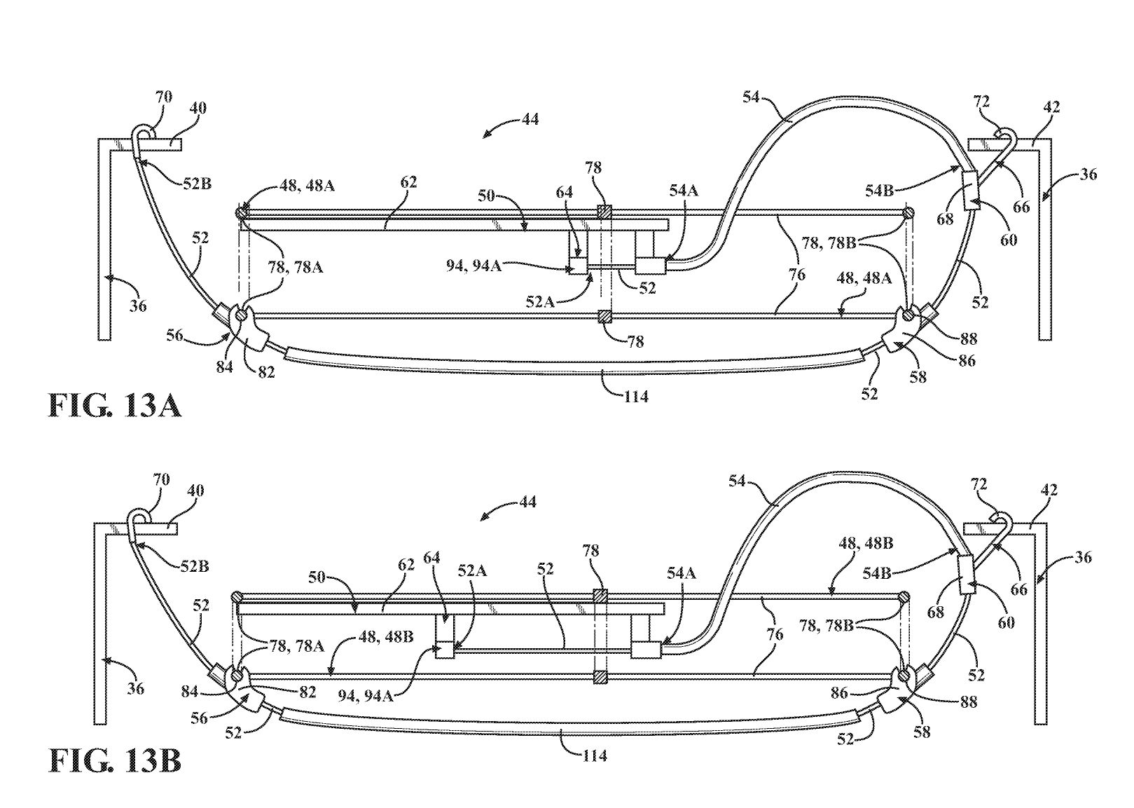

The seat support 48 is adapted for suspension in the back frame 36 of the seat 20 and is selectively movable between a first lumbar position 48A and a second lumbar position 48B (see FIGS. 13A-13B). The actuator 50 is operatively attached to the seat support 48 and concurrently moves with the seat support 48 between the lumbar positions 48A, 48B. To that end, the actuator 50 has a chassis 62 and a drive mechanism 64 for selectively moving the wire 52 with respect to the chassis 62. The wire 52 extends between first and second longitudinal ends 52A, 52B. The first longitudinal end 52A of the wire 52 operatively engages the drive mechanism 64 of the actuator 50. The second longitudinal end 52B of the wire 52 is adapted for attachment to the back frame 36 of the seat 20. The conduit 54 is disposed about at least a portion of the wire 52 and has first and second conduit ends 54A, 54B. The first conduit end 54A of the conduit 54 is coupled to the actuator 50 (see FIG. 2). The first guide 56 is mounted to the seat support 48 adjacent to the second end 52B of the wire 52 with a portion of the wire 52 slidably supported by the first guide 56. Similarly, the second guide 58 is mounted to the seat support 48 spaced from the first guide 56 with a portion of the wire 52 slidably supported by the second guide 58. The intermediate mounting device 60 has a mount 62 adapted for attachment to the back frame 36 of the seat 20. A portion of the wire 52 is supported by the intermediate mounting device 60, and the second conduit end 54B of the conduit 54 is mounted to the intermediate mounting device 60 such that predetermined movement of the drive mechanism 64 of the actuator 50 moves the wire 52 relative to the guides 56, 58 and the intermediate mounting device 60 so as to facilitate movement of the first guide 56 relative to the second end 52B of the wire 52 and movement of the second guide 58 relative to the intermediate mounting device 60, thereby effecting corresponding movement of the seat support 48 between the lumbar positions 48A, 48B (see FIGS. 13A-13B).

As shown best in FIGS. 2-2A, the intermediate mounting device 60 is spaced from the seat support 48. Specifically, the intermediate mounting device 60 guides the wire 52 from the conduit 54 towards the guides 56, 58, but does not move with respect to the back frame 36 of the seat 20 as the drive mechanism 64 of the actuator 50 moves the wire 52 to effect corresponding movement of the seat support 48 between the lumbar positions 48A, 48B, as noted above. Moreover, the intermediate mounting device 60 remains spaced from the guides 56, 58 along the wire 52 as the seat support 48 moves between the lumbar positions 48A, 48B.

As shown throughout the drawings, the wire 52 is continuous between the longitudinal ends 52A, 52B and extends slidably through the conduit 54, the guides 56, 58, and the intermediate mounting device 60. Thus, the wire 52 at least partially passes through the conduit 54, the guides 56, 58, and the intermediate mounting device 60. In one embodiment, the intermediate mounting device 60 includes a device body, generally indicated at 68, which encloses at least a portion of the wire 52. As shown best in FIG. 2A, the device body 68 has a substantially curved profile shaped to direct the wire 52 at least partially towards the guides 56, 58. The mount 66 of the intermediate mounting device 60 extends from and merges with the device body 68.

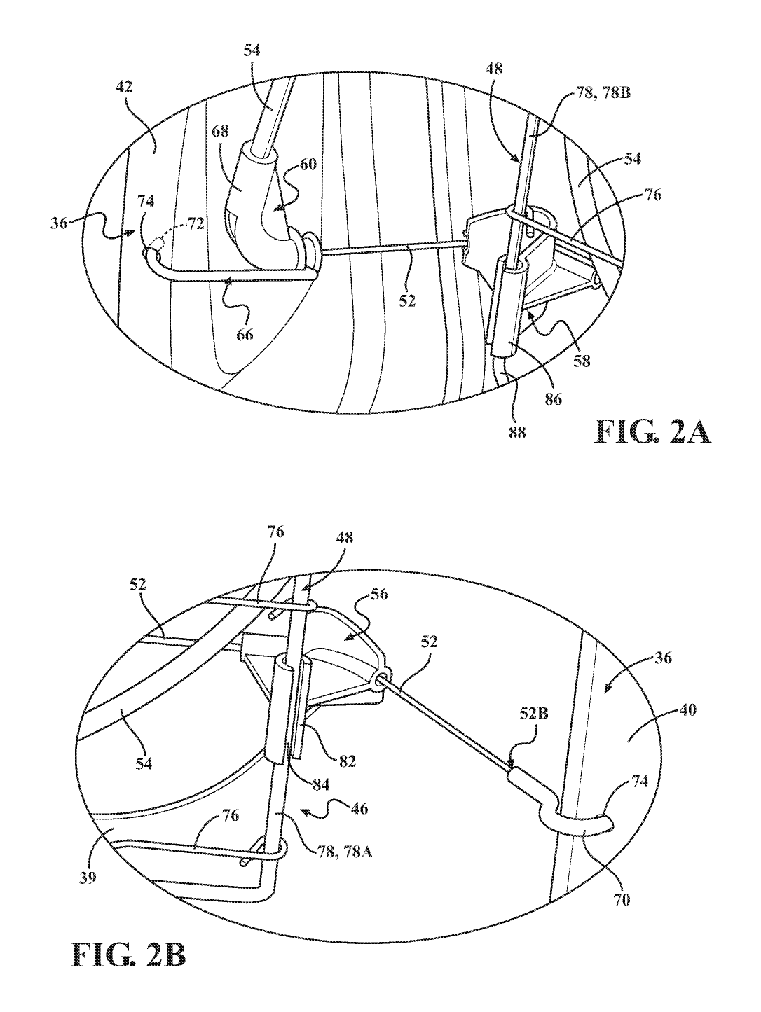

In one embodiment, the wire 52 includes a first hook 70 coupled to the second end 52B of the wire 52, and the mount 66 of the intermediate mounting device 60 includes a second hook 72 (see FIG. 3). The hooks 70, 72 are spaced from each other and are adapted for attachment to the back frame 36 of the seat 20, such as disposed in holes 74 defined in respective side supports 40, 42 of the back frame 36 (see FIG. 2). However, those having ordinary skill in the art will appreciate that second end 52B of the wire 52 and the mount 66 of the intermediate mounting device 60 could be configured differently and could attach to the back frame 36 of the seat 20 in a number of different ways, with or without the use of hooks 70, 72 without departing from the scope of the present invention. Further, as will be appreciated from the subsequent description of the actuator 50 below, the wire 52 could be of any suitable type, manufactured from any suitable material, sufficient to move through the conduit 54, the guides 56, 58, and the intermediate mounting device 60, without departing from the scope of the present invention. By way of non-limiting example, the wire 52 could be realized as a solid wire, as a braided wire, or as a stranded wire.

As noted above, the seat support 48 is adapted for suspension in the back frame 36 of the seat 20. In the representative embodiment illustrated herein, the seat support 48 is mounted within the back frame 36 of the back 26 of the seat 20 and provides adjustable lumbar support to the occupant in the lumbar region 36. More specifically, as noted above, the seat support 48 and the actuator 50 move together between the lumbar positions 48A, 48B, adjacent to the lumbar region 36 of the seat 20, in response to movement of the drive mechanism 64 of the actuator 50, as described in greater detail below. As shown best in FIGS. 1 and 2, the seat support 48 is a mat-type wire mesh configured to resiliently support the back 26 of the seat 20 so as to provide support to the vehicle 22 occupant. To that end, the seat support 48 includes a plurality of horizontal rods 76 and a plurality of vertical rods 78 supporting the horizontal rods 76. The seat support 48 also includes a plurality of rod hooks 80 formed with the horizontal rods 76 and extending from the vertical rods 78 to the side supports 40, 42 of the back frame 36 so as to suspend the seat support 48 therein. The horizontal rod hooks 80 extend at a constant length beyond the vertical rods 78, thereby maintaining proper separation between the back frame 36 and the seat support 48 above the lumbar region 36 of the seat 20. However, as shown in FIG. 2, rod hooks 80 may also be integrally formed with the vertical rods 78, and may extend to the cross supports 38, 39 of the back frame 36 so as to suspend the seat support 48 therein. As shown in FIG. 2, the rod hooks 80 attach to the back frame 36 within the back 26 of the seat 20 and are spaced from the upholstery cover 34 so as to provide space for the foam or cushion between the seat support 48 and upholstery cover 34, as noted above.

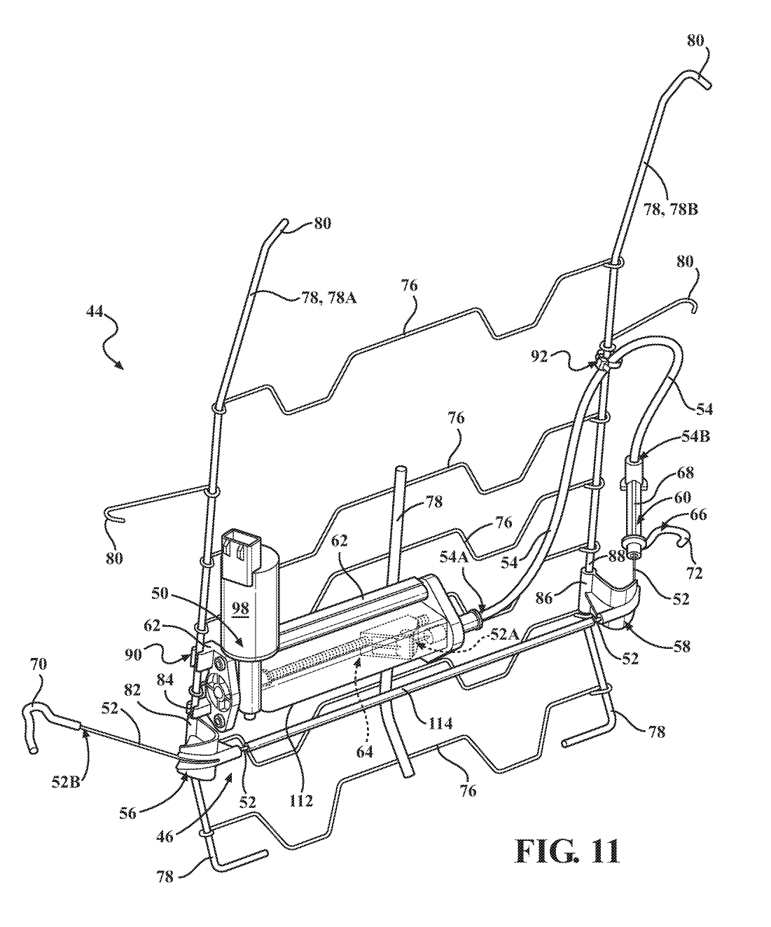

In one embodiment, the seat support 48 of the assembly 44 includes a first vertical rod 78A and second vertical rod 78B spaced longitudinally from the first vertical rod 78A. Here, the first guide 56 is coupled to the first vertical rod 78A, and the second guide 58 is coupled to the second vertical rod 78B. More specifically, in one embodiment, the first guide 56 includes a first guide mount 82 coupled to the seat support 48 at a first location 84 defined by the first vertical rod 78A, and the second guide 58 includes a second guide mount 86 coupled to the seat support 48 at a second location 88 defined by the second vertical rod 78B. The first location 86 is spaced from the second location 88. As shown best in FIGS. 2A-2B, the guide mounts 82, 86 have a substantially c-shaped profile configured for snap attachment to the vertical rods 78 of the seat support 48. Similarly, as shown in the embodiment of the assembly 44 illustrated in FIGS. 11-11A, the chassis 62 of the actuator 50 may include at least one securing feature, generally indicated at 90, configured for attaching the actuator 50 to the vertical rods 78 of the seat support 48, such as via snap attachment. Moreover, while the representative embodiment of the securing feature 90 illustrated in FIG. 11 is realized as a protrusion integrally formed with and extending from the chassis 62 that is clipped onto one of the vertical rods 78 of the seat support 48, it will be appreciated that the securing feature 90 could be formed, configured, oriented, or otherwise realized in any suitable way by any suitable structural feature or component sufficient to secure the actuator 50 to the seat support 48 as described above, without departing from the scope of the present invention. Further, those having ordinary skill in the art will appreciate that the actuator 50 of the assembly 44 can be arranged, oriented, or otherwise supported in any suitable way sufficient to move concurrently with the seat support 48 between the lumbar positions 48A, 48B. Similarly, one or more additional securing mechanisms, generally indicated at 92, could be utilized to secure or otherwise position other portions of the assembly 44, such as one or more “zip ties” 92 employed to secure the conduit 54 to the seat support 48 spaced from the actuator 50 (see FIG. 3).

As noted above, movement of the wire 52 via the drive mechanism 64 of the actuator 50 effects movement of the seat support 48 between the lumbar positions 48A, 48B as the wire 52 moves though the conduit 54, the guides 56, 58, and the intermediate mounting device 60 (see FIGS. 13A-13B). As described in greater detail below, the assembly 44 of the present invention can be implemented, oriented, or configured in a number of different ways depending on the specific configuration of the seat. Moreover, the drive mechanism 64 of the actuator 50 of the assembly 44 can be configured in a number of different ways sufficient to move the wire 52 to effect movement of the seat support 48 between the lumbar positions 48A, 48B, as noted above.

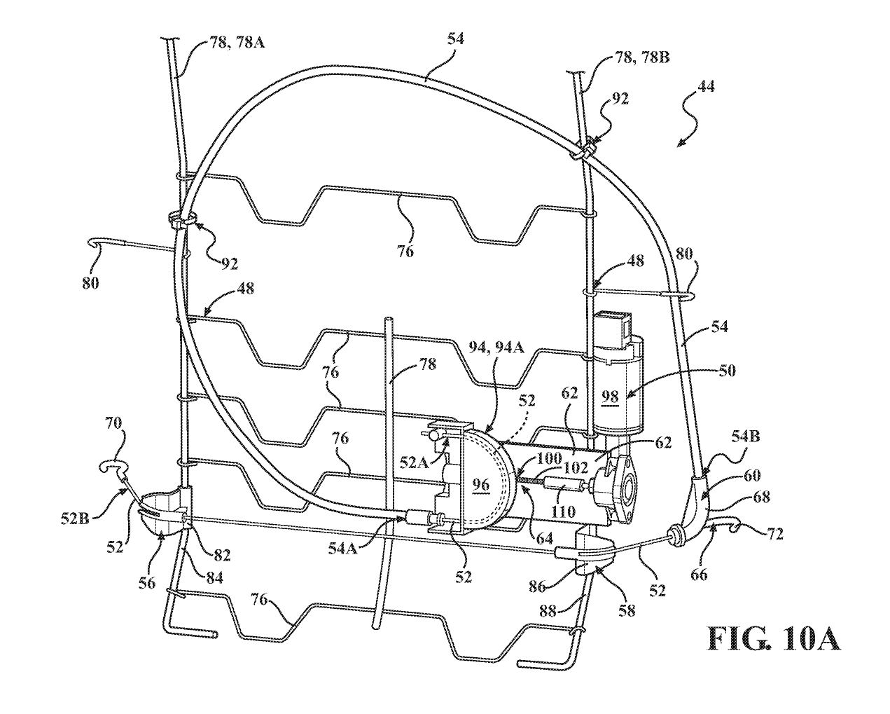

In one embodiment, the drive mechanism 64 of the actuator 50 includes a drive block, generally indicated at 94, which is selectively movable with respect to the chassis 62 of the actuator 50 between a first position 94A corresponding to the first lumbar position 48A (see FIG. 13A), and a second position 94B corresponding to the second lumbar position 48B (see FIG. 13B). Here, as the drive block 94 moves from the first position 94A (see FIG. 9A) to the second position 94B (see FIG. 9B), the wire 52 correspondingly moves through the conduit 54, the guides 56, 58, and the intermediate mounting device 60 so as to effect movement of the seat support 48 between the lumbar positions 48A, 48B (see FIGS. 13A-13B). To that end, in one embodiment, the intermediate mounting device 60 is arranged along the wire 42 adjacent to the second guide 58 such that movement of the drive block 94 from the first position 94A towards the second position 94B urges the second guide 58 towards the intermediate mounting device 60 as the seat support 48 moves from the first lumbar position 48A towards the second lumbar position 48B. Similarly, in one embodiment, the first guide 56 is arranged along the wire 52 such that movement of the drive block 94 of the drive mechanism 64 from the first position 94A towards the second position 94B urges the first guide 56 towards the second end 52B of the wire 52 as the seat support 48 moves from the first lumbar position 48A towards the second lumbar position 48B.

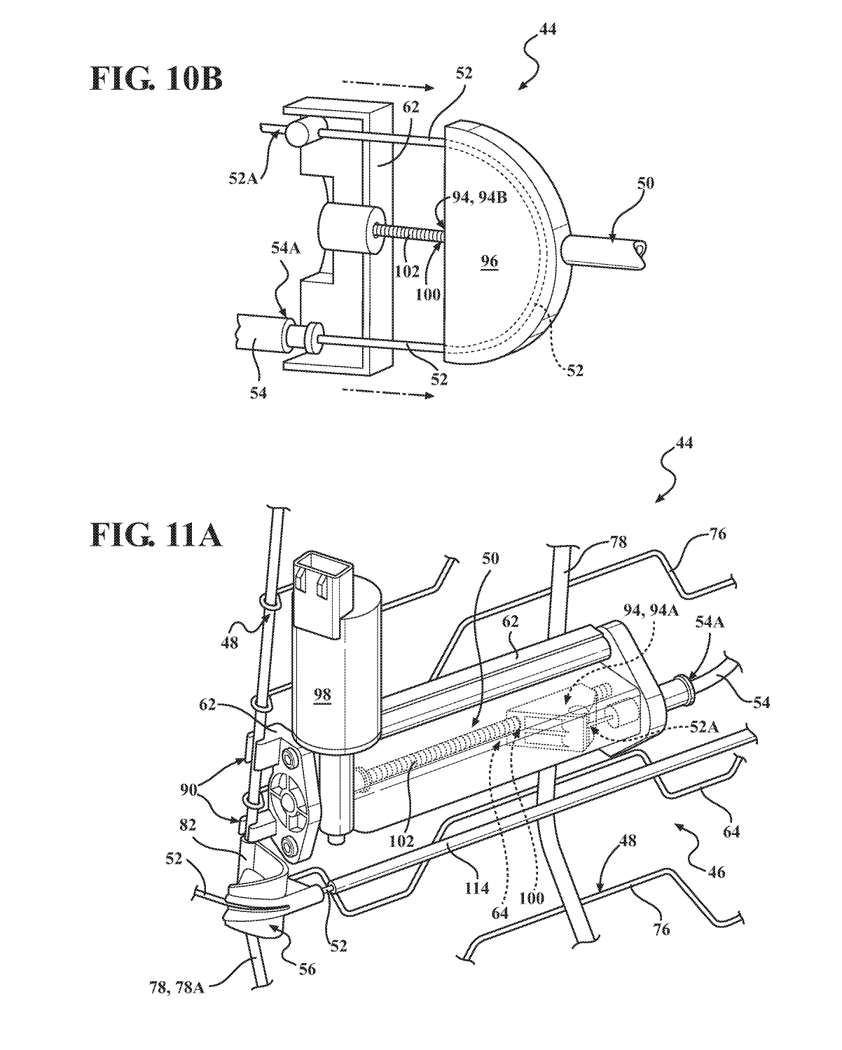

In the representative embodiments illustrated in FIGS. 2-11B and 13A-13B, the first end 52A of the wire 52 is fixed to the drive block 94 of the drive mechanism 64 of the actuator 50 for concurrent movement therewith, and the first conduit end 54A of the conduit 54 is fixed to the chassis 62 of the actuator 50 at a location spaced from the drive block 94 of the drive mechanism 64. Here, movement of the drive block 94 directly moves the wire 52 through the conduit 54, the intermediate mounting device 60, and the guides 56, 58 so as to effect movement of the seat support 48 between the lumbar positions 48A, 48B, as noted above. In the embodiment illustrated in FIGS. 10A-10B, however, the drive mechanism 64 of the actuator 50 further includes a cam, generally indicated at 96, which is fixed to the drive block 94 for concurrent movement, and the cam 96 engages a portion of the wire 52 spaced from and adjacent to the first end 52A of the wire 52. Here, the first end 52A of the wire 52 does not move concurrently with the drive block 94 and is fixed to the drive mechanism 64 at a location spaced from the drive block 94, whereby movement of the wire 52 through the conduit 54, guides 56, 58, and intermediate mounting device 60 is effected as the cam 96 moves into engagement with the portion of the wire 52 adjacent the first end 52A, which slides within or otherwise along the cam 96 as the drive block 94 moves between the positions 94A, 94B. Those having ordinary skill in the art will appreciate that the specific configuration of the cam 96 and drive block 94 can be adjusted for specific application requirements, such as to optimize mechanical advantage based on the geometry of the cam 96 and the movement of the drive block 94. It will be appreciated that the drive block 94 can be configured, supported, and/or shaped in any suitable way sufficient to effect movement of the wire 52 as described above, without departing from the scope of the present invention.

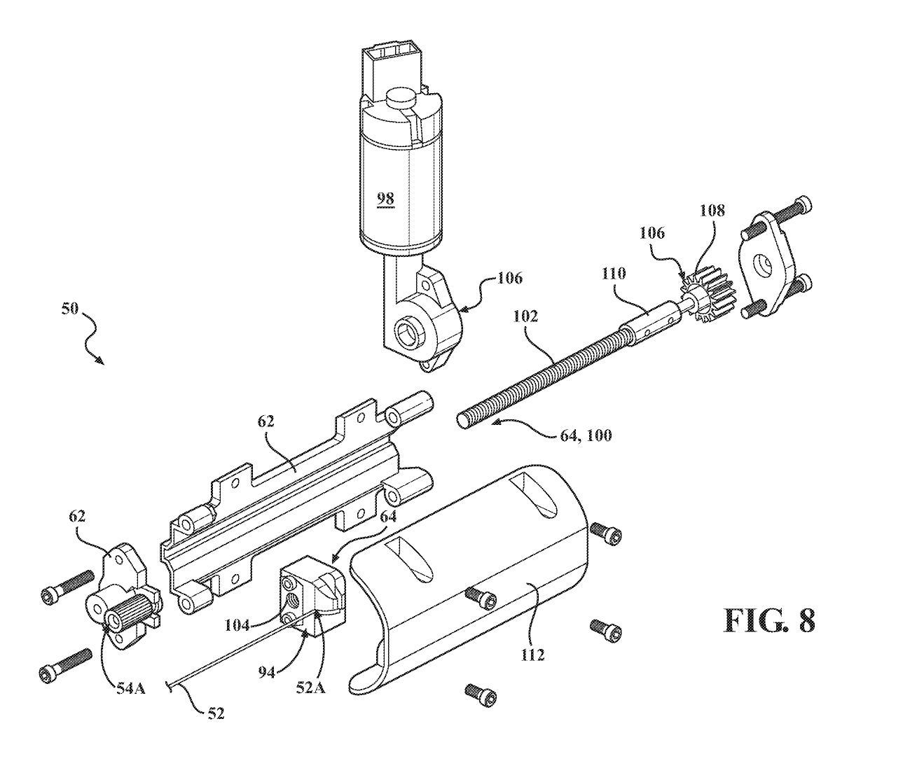

Referring now to FIGS. 7-9B, in one embodiment, the actuator 50 further includes a driver, generally indicated at 98, and a screw drive 100. The driver 98 provides a source of rotational torque in opposing first and second rotational directions 98A, 98B. In one embodiment, the driver 98 is realized as an electric motor. However, it will be appreciated that the driver 98 could be realized by any suitable type of automated prime mover without departing from the scope of the present invention.

The screw drive 100 is supported on the chassis 62 and is disposed in torque-translating relationship with the driver 98. Here, the drive block 94 is supported in threaded engagement with the screw drive 100 such that rotation of the driver 98 in the first rotational direction 98A urges the drive block 94 so as to move the drive mechanism 64 from the first position 94A toward the second position 94B, and rotation of the driver 98 in the second rotational direction 62B urges the drive block 94 so as to move the drive mechanism 64 from the second position 94B toward the first position 94A. To that end, the screw drive 100 includes an externally-threaded rod 102 extending along a portion of the chassis 62 which engages a corresponding internally-threaded portion 104 of the drive block 68 so as to linearly move the drive block 94 and the drive mechanism 64 between the positions 94A, 94B in response to predetermined rotation of the driver 98. It will be appreciated that the specific configuration of the threaded engagement of the screw drive 100 between the threaded rod 102 and the threaded portion 104, such as the pitch, thread count, etc., may be configured to correspond to force output of the actuator 50 necessary to facilitate movement between the lumbar positions 48A, 48B, based on available torque output of the driver 98 and structural characteristics of the seat support 48 and/or the back frame 36 of the seat 20

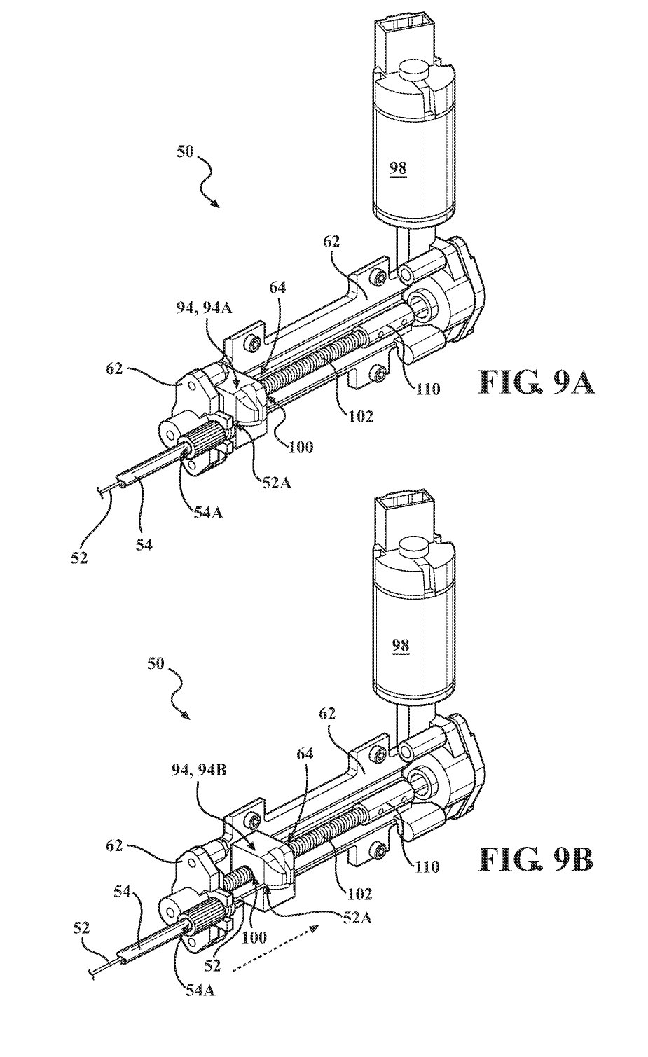

In one embodiment, the actuator 50 further includes a geartrain, generally indicated at 106, interposed in torque-translating relationship between the driver 98 and the screw drive 100. In the representative embodiment illustrated herein, the geartrain 106 includes worm gear 108 coupled to the threaded rod 102 of the screw drive 100 via a coupling, generally indicated at 110, which engages a worm shaft of the driver 98 (worm shaft not shown, but generally known in the art). As shown in FIGS. 7 and 8, the actuator 50 may also include a cover 112 encapsulating the drive mechanism 64, the drive block 94, the screw drive 100, and/or the geartrain 106.

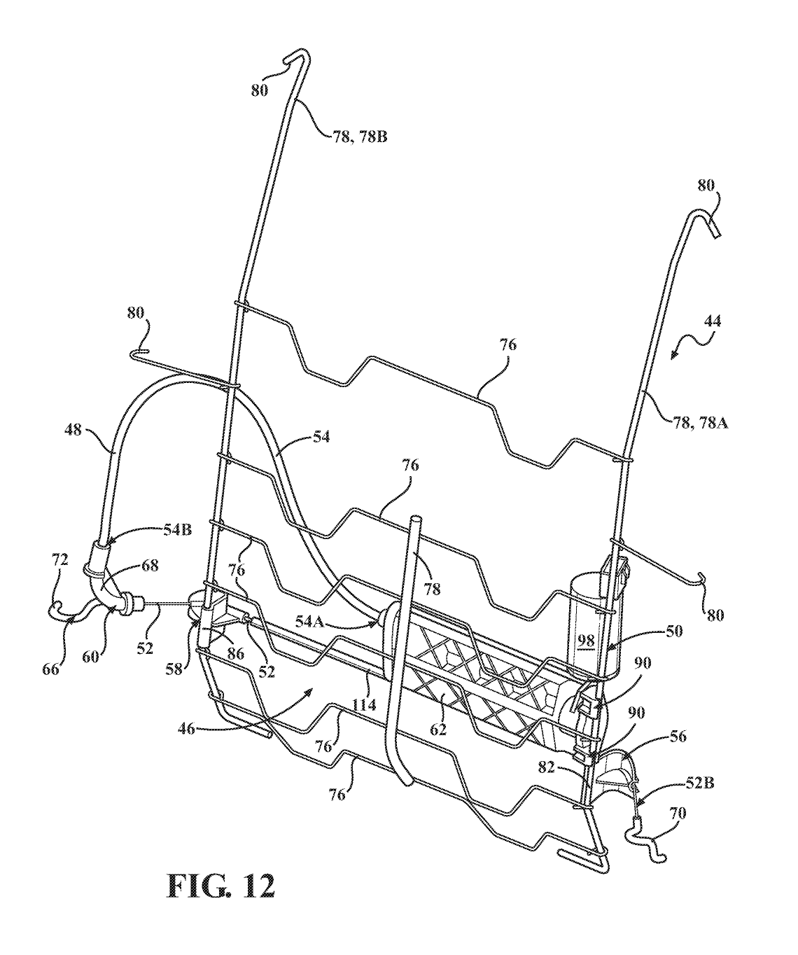

With reference now to FIGS. 11-13B, in one embodiment, the assembly 44 further includes a sheath 114 slidably supported along the wire 52 and disposed between the guides 56, 58. As shown best in FIG. 11A, the sheath 114 is spaced from the guides 56, 58. The sheath 114 provides support to the wire 52 and helps guide the wire 52 between the guides 56, 58 across the seat support 58.

In this way, the assembly 44 of the present invention provides for selective adjustment of the lumbar region 46 of the seat 20 while affording significantly optimized and space-efficient component packaging and, at the same time, reduces the cost and complexity of manufacturing and assembling lumbar adjustment mechanisms for seats 20.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. An assembly for adjusting a lumbar region of a seat having a back frame, said assembly comprising:
a seat support adapted for suspension in the back frame of the seat, with said seat support movable between a first lumbar position and a second lumbar position;
an actuator operatively attached to said seat support to concurrently move with said seat support between said lumbar positions, and said actuator having a chassis and a drive mechanism;
a wire extending between first and second longitudinal ends with said first end of said wire operatively engaging said drive mechanism of said actuator and said second end of said wire adapted for attachment to the back frame of the seat;
a conduit disposed about at least a portion of said wire and having first and second ends with said first end of said conduit coupled to said actuator;
a first guide mounted to said seat support adjacent said second end of said wire with a portion of said wire slideably supported by said first guide;
a second guide mounted to said seat support spaced from said first guide with a portion of said wire slideably supported by said second guide; and
an intermediate mounting device having a mount adapted for attachment to the back frame of the seat, with a portion of said wire supported by said intermediate mounting device, and said second end of said conduit mounted to said intermediate mounting device such that movement of said drive mechanism moves said wire relative to said guides and said intermediate mounting device to facilitate movement of said first guide relative to said second end of said wire and movement of said second guide relative to said intermediate mounting device.

2. The assembly as set forth in claim 1, wherein said intermediate mounting device is spaced from said seat support.

3. The assembly as set forth in claim 1, wherein said intermediate mounting device includes a device body enclosing at least a portion of said wire with said mount of said intermediate mounting device extending from and merging with said device body.

4. The assembly as set forth in claim 3, wherein said device body has a substantially curved profile shaped to direct said wire at least partially towards said guides.

5. The assembly as set forth in claim 1, wherein
said intermediate mounting device remains spaced from said guides along said wire as said seat support moves between said lumbar positions.

6. The assembly as set forth in claim 1, wherein said wire further includes a first hook coupled to said second end of said wire, and wherein said mount of said intermediate mounting device includes a second hook, with said hooks adapted for attachment to the back frame of the seat.

7. The assembly as set forth in claim 1, wherein said wire is continuous between said ends through said guides and said intermediate mounting device.

8. The assembly as set forth in claim 1, wherein said wire is disposed in tension through said guides and said intermediate mounting device and remains in tension as said seat support moves between said lumbar positions.

9. The assembly as set forth in claim 1, wherein said seat support includes a first vertical rod and a second vertical rod spaced longitudinally from said first vertical rod.

10. The assembly as set forth in claim 9, wherein said first guide is coupled to said first vertical rod and said second guide is coupled to said second vertical rod.

11. The assembly as set forth in claim 1, wherein said first guide includes a first guide mount coupled to said seat support at a first location; and wherein said second guide includes a second guide mount coupled to said seat support at a second location spaced from said first location.

12. The assembly as set forth in claim 11, wherein said guide mounts have a substantially c-shaped profile configured for snap attachment to said vertical rods of said seat support.

13. The assembly as set forth in claim 1, wherein said chassis of said actuator includes at least one securing feature for attaching said actuator to said seat support.

14. The assembly as set forth in claim 1, wherein said drive mechanism of said actuator includes a drive block selectively movable with respect to said chassis of said actuator between first and second positions corresponding to said first and second lumbar positions of said seat support.

15. The assembly as set forth in claim 14, wherein said first end of said wire is fixed to said drive block of said drive mechanism for concurrent movement therewith.

16. The assembly as set forth in claim 14, wherein said first end of said conduit is fixed to said chassis of said actuator spaced from said drive block of said drive mechanism.

17. The assembly as set forth in claim 14, wherein said drive mechanism of said actuator further includes a cam fixed to said drive block for concurrent movement therewith, said cam engaging a portion of said wire spaced from and adjacent to said first end of said wire.

18. The assembly as set forth in claim 14, wherein said drive mechanism of said actuator further includes a driver for providing a source of rotational torque in opposing first and second rotational directions, and a screw drive disposed in torque translating relationship with said driver, said drive block being supported in threaded engagement with said screw drive such that rotation of said driver in said first rotational direction urges said drive block from said first position toward said second position and rotation of said driver in said second rotational direction urges said drive block from said second position toward said first position.

19. The assembly as set forth in claim 14, wherein said intermediate mounting device is arranged along said wire adjacent to said second guide such that movement of said drive block of said drive mechanism from said first position towards said second position urges said second guide towards said intermediate mounting device as said seat support moves from said first lumbar position towards said second lumbar position.

20. The assembly as set forth in claim 14, wherein said first guide is arranged along said wire such that movement of said drive block of said drive mechanism from said first position towards said second position urges said first guide towards said second end of said wire as said seat support moves from said first lumbar position towards said second lumbar position.

21. The assembly as set forth in claim 18, wherein said driver of said drive mechanism of said actuator is an electric motor.

22. The assembly as set forth in claim 18, wherein said drive mechanism of said actuator includes a geartrain interposed in torque translating relationship between said driver and said screw drive.

23. The assembly as set forth in claim 1, further including a sheath slidably supported along said wire disposed between said guides and spaced from said guides.

24. The assembly as set forth in claim 1, wherein said wire is either a solid wire, a braided wire, or a stranded wire.
